(19) United States
(12) Patent Application Publication
(10) Pub. No.: US 2013/0265447 A1
(43) Pub. Date: Oct. 10, 2013

(54) COMPUTING DEVICE AND METHOD FOR PROCESSING PICTURES

(71) Applicants: SHENZHEN FUTAIHONG PRECISION INDUSTRY CO., LTD., Shenzhen (CN); CHI MEI COMMUNICATION SYSTEMS, INC., New Taipei (TW)

(72) Inventor: JIE SUN, Shenzhen (CN)

(73) Assignees: Chi Mei Communication Systems, Inc., New Taipei (TW); SHENZHEN FUTAIHONG PRECISION INDUSTRY CO., LTD., Shenzhen (CN)

(21) Appl. No.: 13/849,479

(22) Filed: Mar. 23, 2013

(30) Foreign Application Priority Data
Apr. 6, 2012 (CN) 201210098883.5

(51) Int. Cl. H04N 1/00

(52) U.S. Cl. CPC H04N 1/00204
USPC 348/207.1

(57) ABSTRACT

In a method for processing pictures, an original picture file in a BAYER format received from a mobile phone is read. A bitmap-file header and a bitmap-information header is added to the original picture file. A storage bit number of the added picture file is set, and a bitmap picture corresponding to the added picture file is created according to the storage bit number.

### BACKGROUND

1. Technical Field

Embodiments of the present disclosure generally relate to data processing technology, and particularly to a computing device and a method for processing pictures.

2. Description of Related Arts

Pictures taken by a mobile phone camera may be not clear because of a small camera lens of the mobile phone camera. If the pictures are stored in jpeg format in a mobile phone of the mobile phone camera and transmitted to a computing device, the pictures may be destroyed, and may not be processed effectively.

### BRIEF DESCRIPTION OF THE DRAWINGS

FIG. 1 is a schematic diagram of one embodiment of a computing device.

FIG. 2 is a block diagram of one embodiment of function modules of a processing unit of the computing device in FIG. 1.

FIG. 3 is a flowchart of one embodiment of a method for processing pictures using the computing device in FIG. 1.

FIG. 4 is a flowchart of one embodiment of processing and storing the pictures in a mobile phone.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean “at least one.”

In general, the word “module”, as used herein, refers to logic embodied in hardware or firmware, or to a collection of software instructions, written in a programming language. One or more software instructions in the modules may be embedded in hardware, such as in an erasable programmable read only memory (EPROM). The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

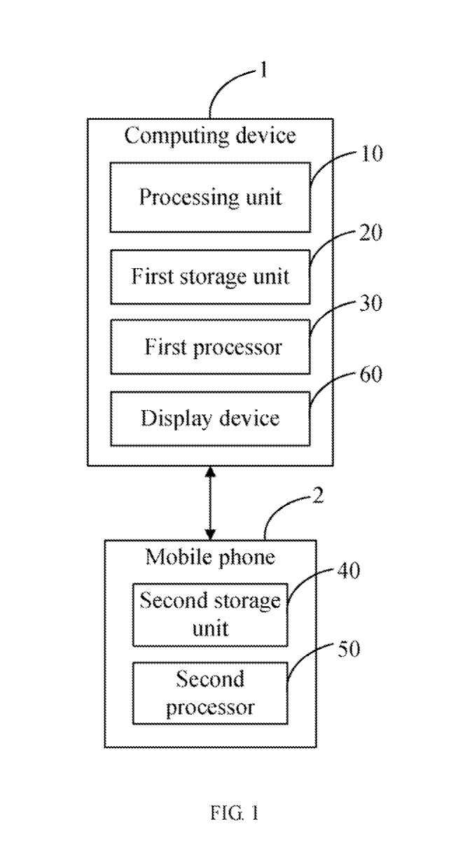

FIG. 1 is a schematic diagram of one embodiment of a computing device 1. In the embodiment, the computing device 1 includes a processing unit 10, a first storage unit 20, a first processor 30, and a display device 60. The computing device 1 processes pictures shot by a mobile phone 2 or other electronic devices. The mobile phone 2 may transmit the pictures to the computing device 1 by a memory card (e.g., a secure digital memory card), a BLUETOOTH unit, a wireless unit (e.g., a WIFI unit) or the Internet, and the first storage unit 20 stores the pictures. The mobile phone 2 includes a second storage unit 40 and a second processor 50. In other embodiments, the pictures may be shot by other electronic devices, such as a tablet computer or a personal digital assistant, for example.

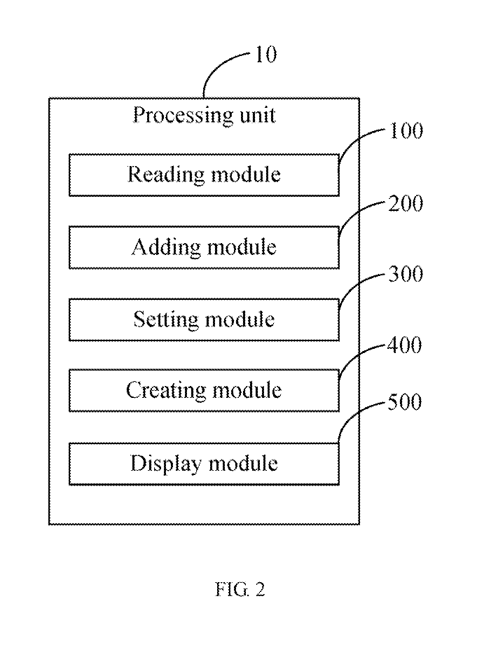

In one embodiment, the processing unit 10 may include one or more function modules (as shown in FIG. 2). The one or more function modules may comprise computerized code in the form of one or more programs that are stored in the first storage unit 20, and executed by the first processor 30 to provide the functions of the processing unit 10. The first storage unit 20 is a dedicated memory, such as an EPROM or a flash memory.

A sensor of a camera (not shown in FIG. 1) of the mobile phone 2 may output data (picture files) in a BAYER format or in a YUV format. A pixel of the data in the BAYER format may be recorded in 12 bits or 14 bits. In the embodiment, the computing device 1 processes original picture files in the BAYER format, and each pixel of the original picture files is recorded in 12 bits. The original picture files are stored in the first storage unit 20 after being transmitted to the computing device 1.

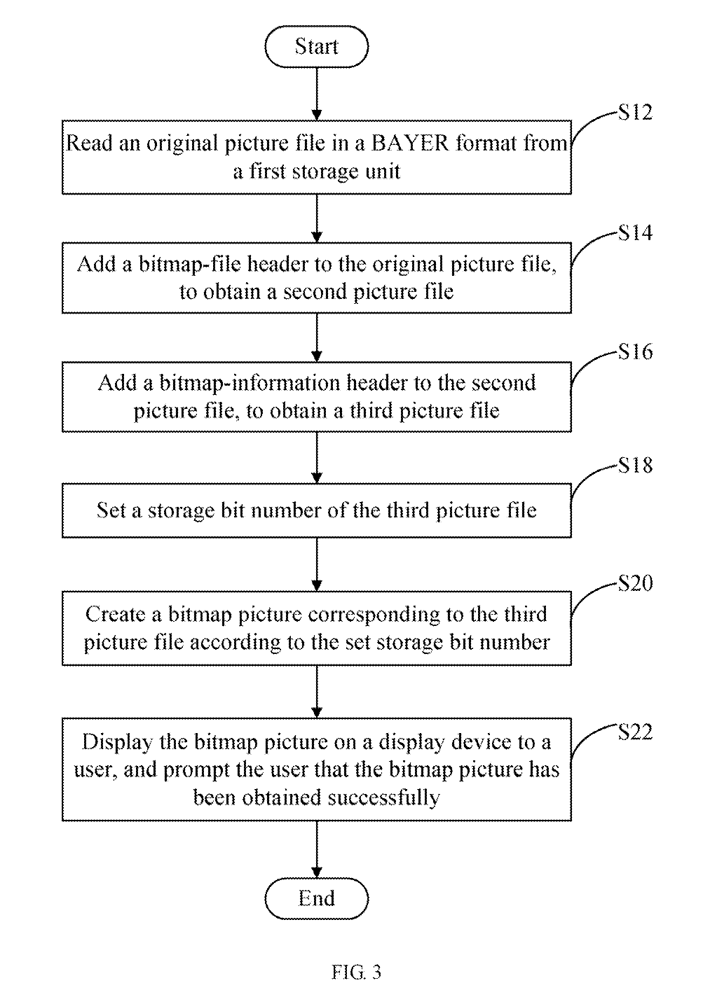

FIG. 2 is a block diagram of one embodiment of the function modules of the processing unit 10. In one embodiment, the processing unit 10 includes a reading module 100, an adding module 200, a setting module 300, a creating module 400, and a display module 500. A detailed description of the functions of the modules 100-500 is given with reference to FIG. 3.

FIG. 3 is a flowchart of one embodiment of a method for processing pictures using the computing device 1. Depending on the embodiment, additional steps may be added, others removed, and the ordering of the steps may be changed, all steps progress in even numbers only.

In step S12, the reading module 100 reads an original picture file in a BAYER format from the first storage unit 20.

In step S14, the adding module 200 adds a bitmap-file header to the original picture file, to obtain a second picture file. The bitmap-file header includes a file type, and a file size, for example.

In step S16, the adding module 200 adds a bitmap-information header to the second picture file, to obtain a third picture file. The bitmap-information header includes a width and a height of the bitmap, for example.

In step S18, the setting module 300 sets a storage bit number of the third picture file. In the embodiment, the set storage bit number is 24 bits.

In step S20, the creating module 400 creates a bitmap picture corresponding to the third picture file according to the set storage bit number. For example, the bitmap picture may be create by calling an application programming interface (API) provided by WINDOWS.

In step S22, the display module 500 displays the bitmap picture on the display device 60 to a user, and prompts the user that the bitmap picture has been obtained successfully. Then, the user can process the bitmap picture (e.g., adjust hue or saturation of the bitmap picture) with a picture processing software (e.g., PHOTOSHOP), to obtain a higher quality picture.

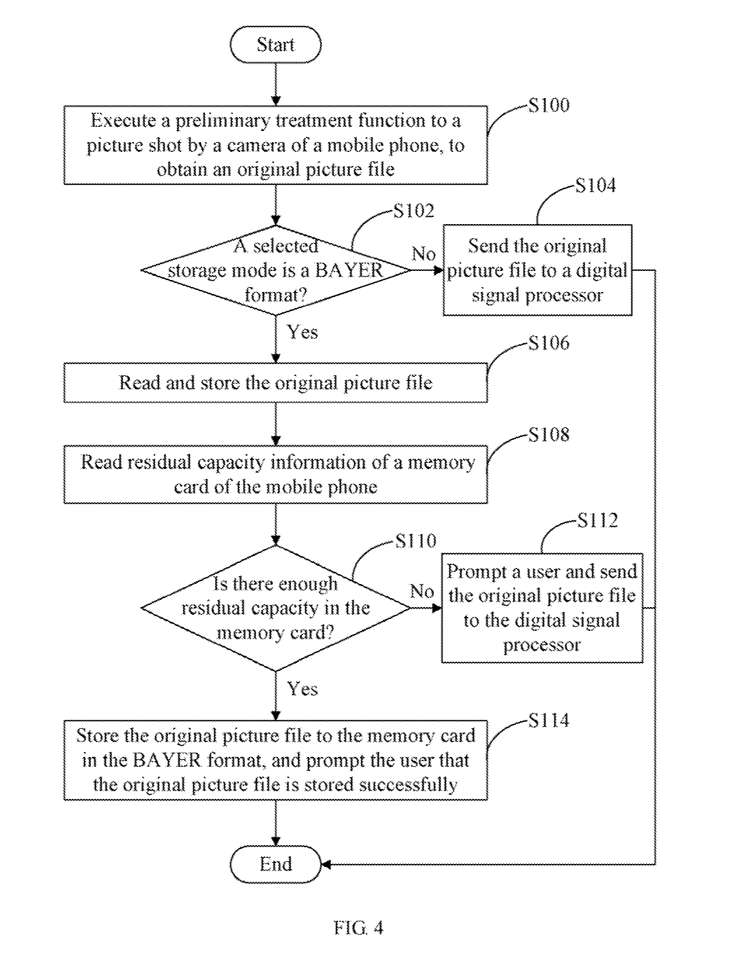

FIG. 4 is a flowchart of one embodiment of processing and storing the pictures in the mobile phone 2. Depending on the embodiment, additional steps may be added, others removed, and the ordering of the steps may be changed, all steps progress in even numbers only.

In step S100, the second processor 50 executes a preliminary treatment function to the picture shot by the camera of the mobile phone 2, to obtain the above-mentioned original picture file. The preliminary treatment function includes adjusting focus, brightness, or contrast of the shot picture, for example.

In step S102, the second processor 50 receives a selected storage mode of the original picture file and determines whether the selected storage mode is the BAYER format. In the embodiment, the storage mode may be the BAYER format or the PUV format. If the selected storage mode is not the BAYER format, step S104 is implemented. If the selected storage mode is the BAYER format, step S106 is implemented.

In step S104, the second processor 50 sends the original picture file to a digital signal processor of the mobile phone 2 to process the original picture file.

In step S106, the second storage unit 40 reads and stores the original picture file, then step S108 is implemented.

In step S108, the second storage unit 40 reads residual capacity information of the memory card of the mobile phone 2. In the embodiment, the second storage unit 40 can read the residual capacity information through corresponding functions.

In step S110, the second storage unit 40 determines whether there is enough residual capacity in the memory card for storing the original picture file in the BAYER format. In the embodiment, if the residual capacity is not less than a resolution of the sensor of the camera multiplied by 12 bits, the residual capacity is enough for storing the original picture file in the BAYER format. If there is not enough residual capacity, step S112 is implemented. If there is enough residual capacity, step S114 is implemented.

In step S112, the second storage unit 40 prompts the user that there is not enough residual capacity in the memory card, and sends the original picture file to the digital signal processor to process the original picture file.

In step S114, the second storage unit 40 stores the original picture file to the memory card in the BAYER format, and prompts the user that the original picture file is stored successfully. In the embodiment, the original picture file in the BAYER format may be named according to a time of shooting the picture. It is understood that in other embodiments, the original picture file may be stored to the second storage unit 40 in the BAYER format, and transmitted to the computing device 1 through the BLUETOOTH unit, the wireless unit or the Internet.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A computer-implemented method being executed by a processor of a computing device, the method comprising:
(a) reading an original picture file in a picture format received from a mobile phone;
(b) obtaining a second picture file by adding a bitmap-file header to the original picture file;
(c) obtaining a third picture file by adding a bitmap-information header to the second picture file;
(d) setting a storage bit number of the third picture file; and
(e) creating a bitmap picture corresponding to the third picture file according to the storage bit number.

2. The method as claimed in claim 1, wherein the mobile phone obtains the original picture file by executing preliminary treatment to a picture shot by a camera of the mobile phone, stores the original picture file in the picture format, and transmits the original picture file to the computing device.

3. The method as claimed in claim 1, wherein the storage bit number is set as 24 bits.

4. The method as claimed in claim 1, wherein the method further comprises:
displaying the bitmap picture on a display device of the computing device, and prompting the bitmap picture is obtained successfully on the display device.

5. The method as claimed in claim 2, wherein the mobile phone transmits the original picture file to the computing device by a memory card, a BLUETOOTH unit, a wireless unit or the Internet.

6. A non-transitory storage medium storing a set of instructions, the set of instructions being executed by a processor of a computing device, to perform a method comprising:
(a) reading an original picture file in a picture format received from a mobile phone;
(b) obtaining a second picture file by adding a bitmap-file header to the original picture file;
(c) obtaining a third picture file by adding a bitmap-information header to the second picture file;
(d) setting a storage bit number of the third picture file; and
(e) creating a bitmap picture corresponding to the third picture file according to the storage bit number.

7. The non-transitory storage medium as claimed in claim 6, wherein the mobile phone obtains the original picture file by executing preliminary treatment to a picture shot by a camera of the mobile phone, stores the original picture file in the picture format, and transmits the original picture file to the computing device.

8. The non-transitory storage medium as claimed in claim 6, wherein the storage bit number is set as 24 bits.

9. The non-transitory storage medium as claimed in claim 6, wherein the method further comprises:
displaying the bitmap picture on a display device of the computing device, and prompting the bitmap picture is obtained successfully on the display device.

10. The non-transitory storage medium as claimed in claim 7, wherein the mobile phone transmits the original picture file to the computing device by a memory card, a BLUETOOTH unit, a wireless unit or the Internet.

11. A computing device, the computing device comprising:
a storage unit;
at least one processor;
one or more programs that are stored in the storage unit and are executed by the at least one processor, the one or more programs comprising:
a reading module that reads an original picture file in a picture format received from a mobile phone;
an adding module that obtains a second picture file by adding a bitmap-file header to the original picture file;
the adding module further obtains a third picture file by adding a bitmap-information header to the second picture file;
a setting module that sets a storage bit number of the third picture file; and
a creating module that creates a bitmap picture corresponding to the third picture file according to the storage bit number.

12. The computing device as claimed in claim 11, wherein the mobile phone obtains the original picture file by executing preliminary treatment to a picture shot by a camera of the mobile phone, stores the original picture file in the picture format, and transmits the original picture file to the computing device.

13. The computing device as claimed in claim 11, wherein the storage bit number is set as 24 bits.

14. The computing device as claimed in claim 11, wherein the one or more programs further comprises:
a display module that displays the bitmap picture on a display device of the computing device, and prompts the bitmap picture is obtained successfully on the display device.

15. The computing device as claimed in claim 12, wherein the mobile phone transmits the original picture file to the computing device by a memory card, a BLUETOOTH unit, a wireless unit or the Internet.
